(19) United States
(12) Patent Application Publication
(10) Pub. No.: US 2009/0248418 A1
(43) Pub. Date: Oct. 1, 2009

(54) Speech Recognition and Statistics-Based Call Route Determination

(75) Inventors: Peeyush Jaiswal, Boca Raton, FL (US); Naveen Narayan, Flower Mound, TX (US); Sheri Gayle Daye, Boca Raton, FL (US)

Correspondence Address: WOLF GREENFIELD & SACKS, P.C., 600 ATLANTIC AVENUE, BOSTON, MA, 02210-2206, US

(73) Assignee: INTERNATIONAL BUSINESS MACHINES CORPORATION, Armonk, NY (US)

(21) Appl. No.: 12/059,144

(22) Filed: Mar. 31, 2008

(51) Int. Cl. G10L 21/00

(52) U.S. Cl. 704/275

(57) ABSTRACT

A method of call route determination based upon a statistics-based business intelligence engine (BEI) queried by an IVR subsystem with caller parameters descriptive of the caller to determine a next best route for a received call, when the default or best route for the call exceeds a threshold time. A call is received at a contact center from a caller. Content and identity information of the caller is extracted from the received call. IVR determines a first estimated wait time associated with a default route of the received call. If the first estimated wait time is greater than a threshold time, and thus unacceptable, then the IVR queries a business intelligence engine (BIE) with caller parameters descriptive of the caller to determine a next best route of the received call, with the next best route having a second estimated wait time less than the first estimated wait time of the default route. The caller is then routed to the next best route.

### BACKGROUND

Modern day contact (call) centers generally use a combination of Interactive Voice Response (IVR) technology and a set of speech recognition servers to perform two functions related to routing a received call to the best possible route. First, the nature of an incoming call is identified. Second, the best possible route for the received call is determined. The most suitable agent for handling this call may then be determined. For instance, a call requiring certain skills of the person handling the call would be routed to an operator possessing those skills.

Call handling, however, is also load dependent, meaning that the higher the call volume received in a given contact center, the longer it will generally take for the next call to be answered by an agent. Contact centers attempt to mitigate this delay in a variety of ways. First, they might try to resolve the call within the IVR system by providing a self-service option for the caller. Second, more agents might be added to handle incoming calls. Third, the granularity associated with handling call routing might be improved by identifying the type of call and then routing the call to the agent or agent group best equipped to handle that type of call.

It is known that speech recognition systems of contact centers are generally programmed with directed speech or natural language programming; asking the right questions are necessary to determine the appropriate call route destination for each incoming call. Irrespective of the approach chosen to handle an incoming call, speech recognition system are generally unintelligent systems that take a spoken sentence as input and provide the “recognized” output to the IVR to make the call routing decisions accordingly. Moreover, current IVR systems may attempt to increase the granularity of identifying the call in order to route it, but they generally do not predict alternative menu selections depending on contact center load.

While some IVR systems use caller profiling to identify caller selections to better route an incoming call, IVR systems that use real-time algorithms based upon dialed number identification service (DNIS) and existing load conditions to determine next-best call routing do not exist.

### BRIEF SUMMARY

In accordance with embodiments consistent with the present invention, a method of call route determination based upon a statistics-based business intelligence engine (BEI) queried by an IVR subsystem with caller parameters descriptive of the caller to determine a next best route for a received call, when the default or best route for the call exceeds a threshold time. A call is received at a contact center from a caller. Content and identity information of the caller is extracted from the received call. IVR determines a first estimated wait time associated with a default route of the received call. If the first estimated wait time is greater than a threshold time, and thus unacceptable, then the IVR queries a business intelligence engine (BIE) with caller parameters descriptive of the caller to determine a next best route of the received call, with the next best route having a second estimated wait time less than the first estimated wait time of the default route. The caller is then routed to the next best route.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a flow of a method for statistics-based call route determination, in accordance with certain embodiments.

FIG. 2 is a sequence diagram illustrating a statistics-based call route determination, in accordance with certain embodiments.

### DETAILED DESCRIPTION

In accordance with embodiments consistent with the present invention, a method of call route determination based upon a business intelligence engine (BEI), a statistics engine, queried with caller parameters descriptive of the caller to determine a next best route for a received call, when the default or best route for the call exceeds a threshold time. A set of rules coupled with the BEI is used to determine an alternative route (the next best route) for a call after it has been determined that the best fit route is greater than a threshold time and thus not going to be available for a pre-configured maximum time that is unacceptable. In a certain embodiment, based upon current hold times in a call queue, the DNIS of the received call, and the menu selections made by the caller during the call, the combination of IVR and speech subsystem technologies can be used to determine a set of alternative routes that can be applied to the call, providing an option other than just the default route (such as the best fit route). The one or more alternative routes, i.e. next best routes, can be provided to the caller and, based upon the caller's selection, the call may be routed to one of the alternative routes.

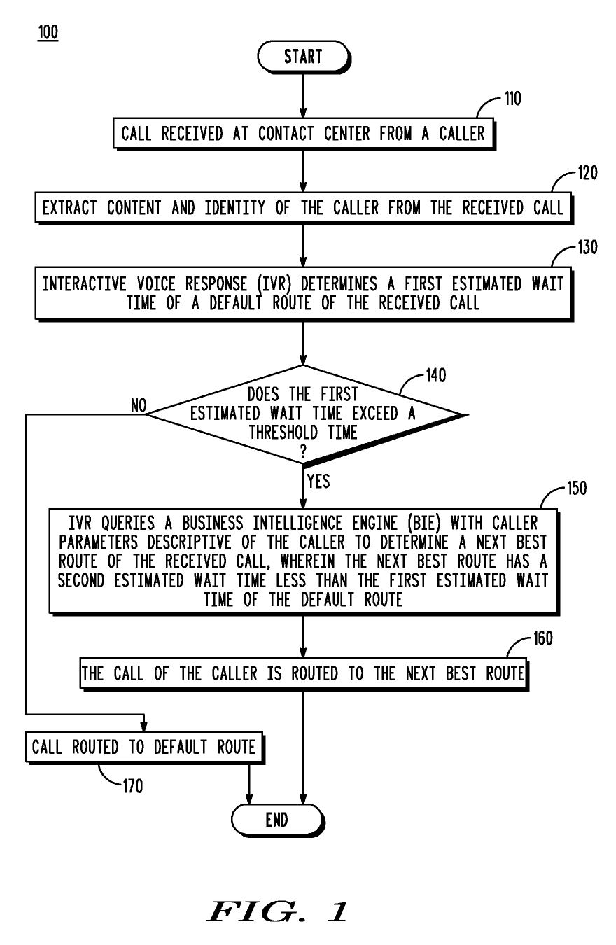

Referring now to FIG. 1, flow 100 illustrates an approach for statistics-based call route determination. A call is received at a contact center from the caller at Block 110. At Block 120, the content and identity of the caller are extracted from the received call. At Block 130, the IVR system determines a first estimated wait time of a default route, such as a best route, of the received call. At Decision Block 140, the inquiry is whether the first estimated wait time exceeds a certain threshold time. If yes, then at Block 150, the IVR system the queries a statics-based BIE with caller parameters descriptive of the caller to determine a next best route of the received call. The next best route has a second estimated wait time that is less than the first estimated wait time of the default route. At Block 160, the call of the caller is then routed to the next best route with the shorter next best route. If no, however, then the flow from Decision Block 140 continues to Block 170, where the call is routed to the default route.

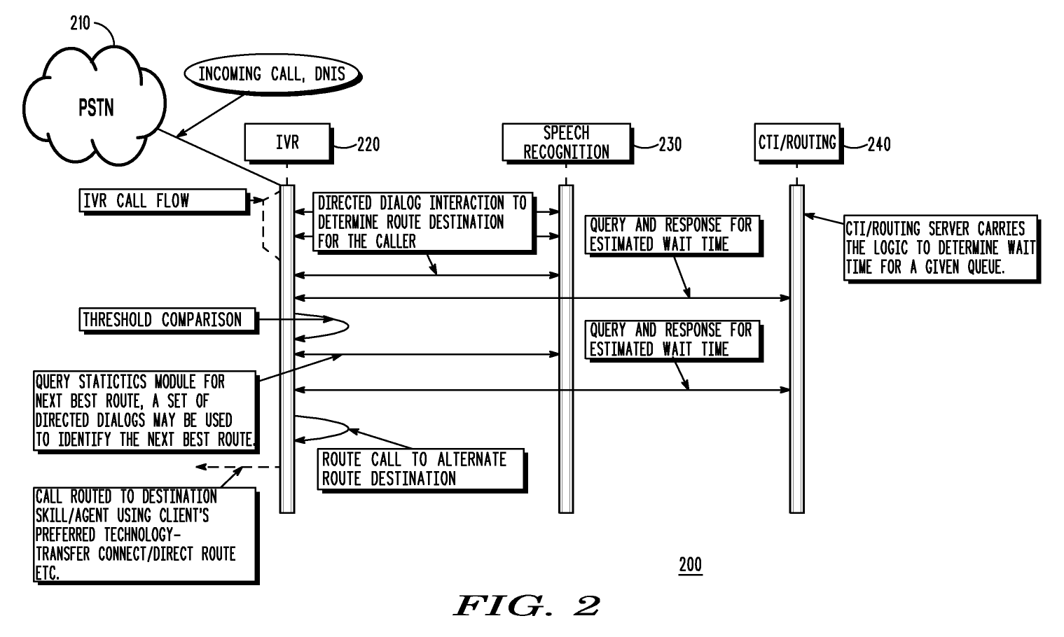

This approach is also illustrated in the sequence diagram 200 of FIG. 2, which has three components to consider: IVR 220, speech recognition 230, and CTI/routing server 240. An incoming call, identified by DNIS, is received by an IVR system 220 from PSTN 210. The IVR call flow portion relates that the IVR and speech recognition options are used to determine a route destination of the caller. The CTI/routing server 240 performed a query and response function to determine an estimated wait time for the call for the best fit route. As noted, CTI/Routing 240 server has logic to determine the wait time for a given route. A threshold comparison is then performed. The BEI statistics module is queries to determine one or more next best routes; a set of directed dialogs, speech recognition driven, may be performed with the caller to identify the next best route. The IVR can then route the call to the next best route. As indicated, the next best route may take into account the skill of the agent needed for a particular caller, such as the caller's preferred method of contact (transfer connect or direct routing, for example). It is noted that the BEI statistics-based engine may have a number of information about a caller, such as previous buying history, previous interactions with the call center or sales personnel, previous purchases, socioeconomic indicators, etc., that may individually or in the aggregate be useful for directing the caller to a next best route that will be shorter than a threshold time as well as be more targeted to the needs and expectations of the particular caller.

Consider an example in which a caller is a subscriber to an automobile insurance and road side assistance club. A call arrives from the caller to the roadside assistance contact center on DNIS 7899, identifying the caller as being a subscriber of roadside assistance. From the speech recognition technology and the DNIS used by the contact center, the speech content and identity of the caller may be extracted. The IVR system determines that the estimated wait time in the roadside assistance queue for this call is over 10 minutes, greater than a threshold time of 3 minutes. The IVR next queries the BEI statistic engine with the DNIS, automatic number identification (ANI) and any other caller-specific parameters for the next best fit route destination. This may be further assisted by the IVR system requesting the speech server for a set of directed dialogs with the caller to better identify the next best route. As an example, statistically, the next best route may be the “Member Services Queue” or the “elite Members Queue” (determined from the ANI). Or, the next best route may be determined from a set of directed dialogs with the caller that reveal that the caller has a motorcycle that is un-insured and thus the caller would be transferred to the “uninsured caller queue.” It can seen in such a circumstance that the next best route need not necessarily be the route with the best estimated wait time. Indeed, the use of the statistics-based BIE allowed any manner of statistical information collected about the user to be used in the next best route determination. It is noted that the next best route determination is determined in real-time, i.e. during the time that the caller is holding for service. IF this wait time is below the threshold time, then the call is routed to the next best route destination. Otherwise, the process is repeated until any one of the previous routes becomes available or another best route for the call is determined.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of statistics-based call route determination, comprising:
receiving a call from a caller at a contact center;
extracting content and identity of the caller from the received call;
an interactive voice response (IVR) system determining a first estimated wait time of a default route of the received call;
if the first estimated wait time of the default route exceeds a threshold time, further comprising:
the IVR system querying a statistics-based business intelligence engine (BIE) with caller parameters descriptive of the caller to determine a next best route of the received call, wherein the next best route has a second estimated wait time less than the first estimated wait time of the default route; and
routing the call of the caller to the next best route; and if the first wait time of the default route does not exceed a threshold time, routing the call of the caller to the default route.
